(19) United States
(12) Patent Application Publication
(10) Pub. No.: US 2021/0251185 A1
(43) Pub. Date: Aug. 19, 2021

(54) PET SHOWER

(71) Applicant: Leon Whitsett, Detroit, MI (US)

(72) Inventor: Leon Whitsett, Detroit, MI (US)

(21) Appl. No.: 17/147,046

(22) Filed: Jan. 12, 2021

Related U.S. Application Data
(63) Continuation-in-part of application No. 14/018,416, filed on Sep. 5, 2013, now abandoned.

(51) Int. Cl. A01K 13/00

(52) U.S. Cl. CPC A01K 13/001

(57) ABSTRACT

The present invention provides a pet shower having an upper washing compartment and a lower stowage area. An interiorly disposed multi-apertured conduit in fluid communication with an exterior source provides a “shower” for washing the animal. Portals, having gloves mounted thereto, enable washing of the animal without having the hands of the user exposed to the interior. The washing compartment is detachably mounted to the stowage area in which is stowed a tub which defines, in a first instance, a step enabling an animal to step upon to enter the interior of the washing apparatus and, when inverted, may be used as a drainage tub for draining from water within the compartment.

### CROSS-REFERENCE TO RELATED APPLICATION

This Application is a continuation in part of Co-pending U.S. patent application Ser. No. 14/018,416, filed on Sep. 5, 2013 for “A Pet Washing Apparatus for Dogs and Like Animals,” the disclosure of which is hereby incorporated by reference, including the drawings.

### BACKGROUND OF THE INVENTION

### 1. Field of the Invention

The present invention concerns a washing apparatus. More particularly, the present invention concerns a pet washing apparatus for dogs and other animals.

### 2. Prior Art

In the above-referenced co-pending application, there is disclosed a “shower” for facilitating the washing of dogs and similar type pets. The device shown therein, while being extremely efficacious, has certain drawbacks, including, inter alia, difficulty in manufacture because of the dual wall system disclosed therein, through which the necessary water delivery conduits are disposed. Furthermore, the “portability” of this prior device was, in essence, non-existent.

Thus, the present invention seeks to improve upon such prior art device by having improved air circulation, water delivery and discharge, as well as ease of manufacture and portability.

For a more complete understanding of the present invention, reference is made to the following detailed description and accompanying drawing. In the drawing, like reference characters refer to like parts throughout the several views in which:

### DESCRIPTION OF THE DRAWING

FIG. 1 is a perspective view showing the shower;

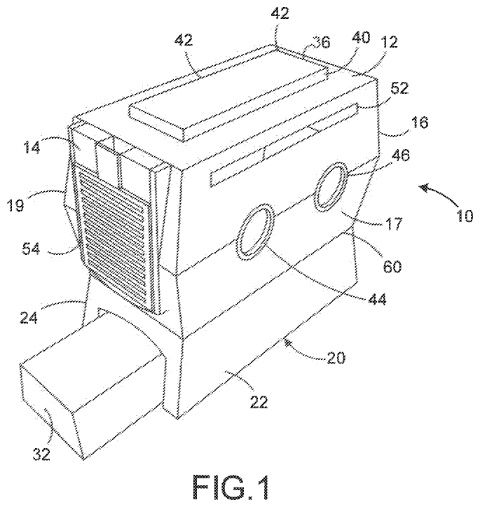

FIG. 2 is a front view thereof;

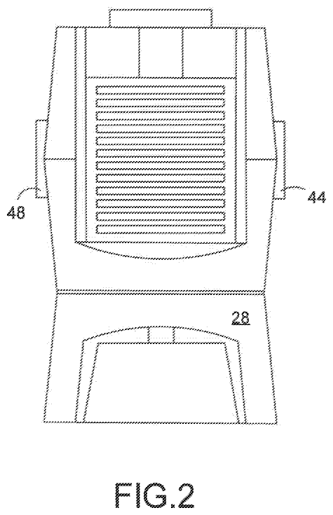

FIG. 3 is a partial cut-away view showing the interior of the present washing apparatus;

FIG. 4 is a top view thereof;

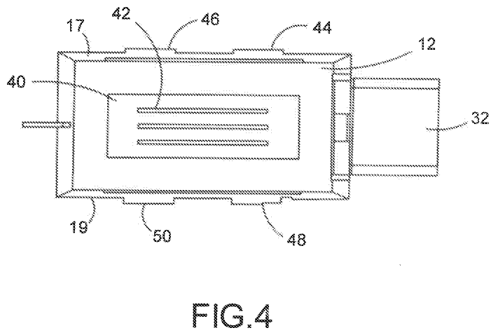

FIG. 5 is a side view of the present shower;

FIG. 6 is a disassembled view of the present washing apparatus; and

FIG. 7 shows a basket with accessories emplaced therein.

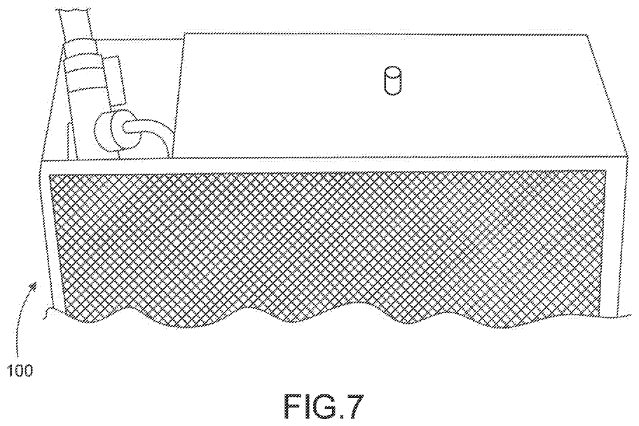

### DESCRIPTION OF THE INVENTION

Now, and with reference to the drawing, there is shown therein a washing apparatus or pet shower particularly adapted for use with dogs and other like pets, generally shown at 10. The present device includes a shower compartment 11, having a top wall 12, a front wall 14, a rear wall 16, a bottom wall or floor 18 and a pair of opposed side walls 17, 19 and which cooperate to define an interior washing area 21.

The present apparatus or device also includes a storage or stowage area or enclosure 20, which is removably attached to the washing compartment 11. The storage area has an open interior defined by a pair of opposed sidewalls 22, 24, a rear wall 26, and a front wall 28. As shown, the front wall has an access 30 in which is removably stowed a combined seat/step and drainage tub 32, as detailed hereinbelow.

The combined seat and drainage or tub 32 is removably stowed within the open interior of the storage area.

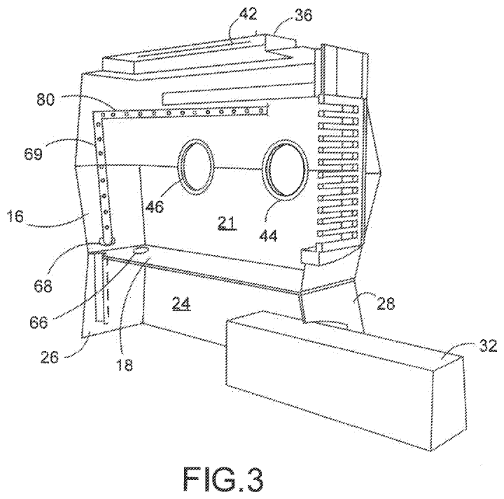

With more particularity, and as shown in FIG. 3, the top wall or roof 12 of the washing compartment 11 has a venting area 36 comprising a raised section 40. A plurality of slats 42 are formed in the section 40. The slats 42 are in communication with the interior 21. The slats provide circulatory air into the interior and facilitate not only entry of air, but exhaust of air from the interior.

Each side wall 17, 19 has a pair of spaced apart portals, 44, 46, 48, 50. A pair of portals are provided on each side wall and provide access into the interior washing area 21 of the compartment.

Suitable hand coverings 23, such as gloves 25 or the like are sealingly, fixedly attached to each portal to enable the user to cover his/her hands while washing an animal therewithin.

A viewing opening 52 is formed on each side wall 17, 19 to enable a user to observe the washing, depending on which side the user decides to use while washing the animal.

As shown in the drawing, an access or door 54 is hingedly or otherwise mounted to the front wall 14 and which enables easy entry of an animal into the interior 21 of the washing compartment. In this regard, the tub 32 can be used as a step to facilitate entry into the interior by the animal.

The door or portal 54 which has a perimetrical seal is slatted similarly to that of the venting area formed in the top wall 12 to facilitate air circulation within the interior.

The bottom wall or floor 18 of the interior 21 of the compartment 11 is angularly inclined with respect to the horizontal to facilitate drainage therefrom.

A drainage hole 60 is provided in the floor and communicates with a suitable outlet 66 which, when opened and placed in connection with a hose (not shown) facilitates drainage of water from the interior 21.

A connector 68 is disposed on one sidewall and is used to connect a water delivery source to the interior 21 of the compartment. The connector 68 is in fluid communication with a multi-apertured conduit 69 which extends, at least partially, about the interior of the apparatus. The conduit 69 extends from proximate the rear wall 16 and about the roof 12 of the interior.

Optionally, the conduit can extend vertically downwardly in proximity to the front wall. Thus, water or other fluid is delivered into the interior from a hose 71 and used as a spray for facilitating the washing of the animal. The conduit 69 can be a multi-apertured PVC tube or similar light weight conduit.

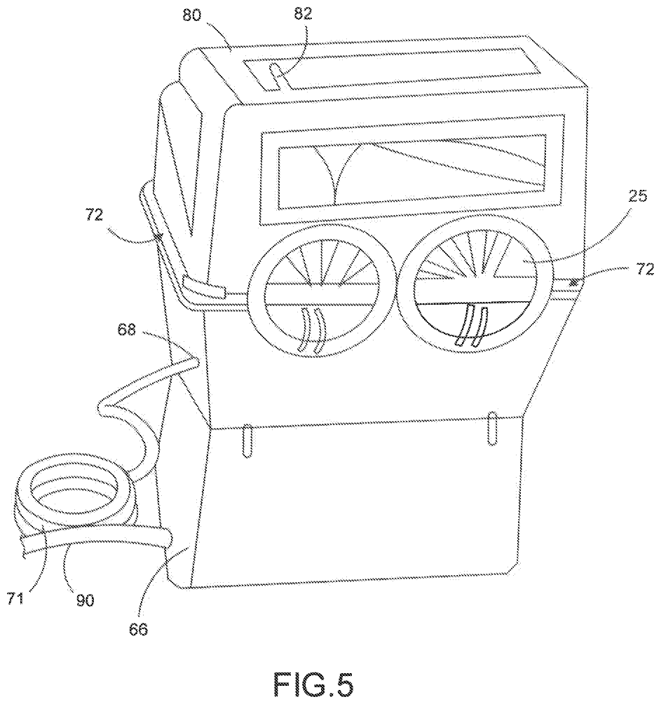

Referring now to FIG. 5 as shown, a plurality of latches 72 are disposed about the perimeter of the exterior of the washing apparatus. Each latch has a first element 74 disposed on the exterior wall of the stowage area and a co-operable locking mechanism 76 disposed on the interior of the compartment in the well-known manner, such as typical connecting latches or the like. Thus, the stowage area and the washing apparatus are detachably interlockable.

As noted above, the tub 32 can be used as both a step and, when inverted or turned over, as a drainage collector by placing it in fluid communication with a drain hose 96.

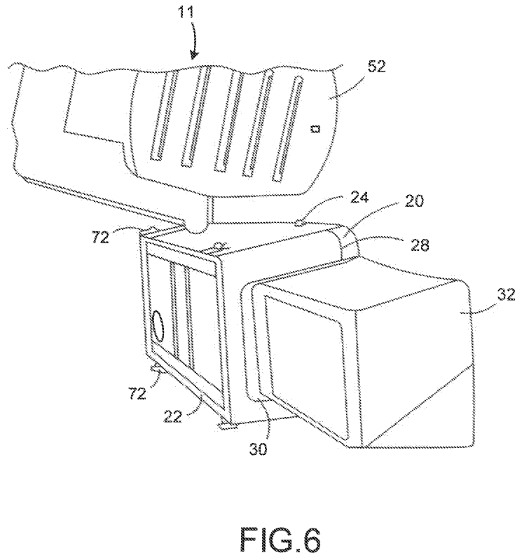

Furthermore, as shown in FIG. 6, because of the dimensioning, the stowage area is storable within the interior washing area 21 of the washing compartment and, in turn, the tub 32 is stowable within the storage area (FIG. 5), thereby rendering the present invention easily transportable.

If desired, a suitable basket or container (not shown) can be placed within the washing apparatus for containing shampoos, brushes and other accessories for facilitating the washing of the animal.

The present device can be manufactured from any suitable synthetic resinous material, such as a light-weight polypropylene or other plastic.

A seal 60 can be placed about the edge of the bottom wall or floor of the device to prevent water from leaking out from the interior 21 when in use.

From the foregoing, it is apparent that there has been described an animal washing device that is easy to use, inexpensive to manufacture and readily transportable.

Having, thus, described the invention, what is claimed is:

1. An animal shower comprising:
(a) an upper shower compartment having a front wall, a rear wall, a top wall, a bottom wall and a pair of opposed side walls, the compartment area being integrally formed as a single unit;
(b) a stowage area having a top wall, a pair of opposed side walls, a rear wall and a front wall, the front wall having an opening formed therein; and
(c) a tub removably stowed within the stowage area, the tub defining a step in a first position and a drainage collector when inverted into a second position.

2. The animal shower of claim 1 which further comprises a seal disposed about the lower edges of the walls of the shower compartment, and wherein the bottom wall is angularly disposed with respect to the horizontal.

3. The animal shower of claim 1 which further comprises a drain outlet in fluid communication with the interior of the shower area to enable drainage of any water collected therewithin.

4. The animal shower of claim 1 which further includes a multi-apertured conduit disposed within the interior of the compartment and having at least a first leg disposed proximate the rear wall and a second leg disposed proximate the top wall interiorly of the stowage compartment, and means for delivering water into the conduit.

5. The animal shower of claim 1 which further comprises at least a pair of portals formed on at least one side wall for facilitating washing of an animal therethrough.

6. The shower compartment of claim 5 which further comprises a viewing portal formed within at least one of the side walls.

7. The animal shower of claim 1 which further comprises a connector in fluid communication with the conduit to enable washing fluid deliverable therethrough and into the conduit.

8. The animal shower of claim 1 which further comprises a valve interposed the conduit, the valve regulating the flow of a washing fluid.
